(19) United States
(12) Patent Application Publication
(10) Pub. No.: US 2002/0079661 A1
(43) Pub. Date: Jun. 27, 2002

(54) Senior citizen walker

(76) Inventor: Eva Fickas, Girard, IL (US)

Correspondence Address: Joseph H. McGlynn, 6111 Saddle Horn Dr., Fairfax, VA, 22030, US

(21) Appl. No.: 09/741,182

(22) Filed: Dec. 21, 2000

(51) Int. Cl. B62M 1/00

(52) U.S. Cl. 280/87.021

(57) ABSTRACT

A combined wheel chair and walker with wheels. A removable seat fits over the fixed lower conventional walker seat. Upright supports attach wheels and one support has a crank and screw gears to provide for the adjusting of the vertical height of the upper portion of the walker. Connecting linkages engage sprockets on shafts and these linkages are made up of chains mount around the sockets. By turning the crank the sprockets turn and connected shafts are moved within the upright supports to change the height of the upper frame and seat relative to the lower ground engaging frame upright supports and their wheels.

### BACKGROUND OF THE INVENTION

This invention relates to a combined wheel chair and walker with wheels that has a removable seat.

Wheel chairs and walkers are known both as separate units and as combined person movers. In one earlier example, a wheel chair/walker with wheels has a handles bar attached to the front wheels. In another earlier related invention, a wheel chair/walker is disclosed with wheels and an open space in front so a person can use the device as a walker.

Another prior art wheel chair /walker has wheels and an adjustable frame.

Still another wheel chair/walker with wheels invention has a seat which is spring biased to a raised position.

On additional wheel chair/walker invention has wheels and a brake locking system for the wheels.

### DESCRIPTION OF THE PRIOR ART

Person movers that are a combined wheel chair and walker are known in the art. For example, U.S. Pat. No. 4,861,051 to Napper discloses a wheel chair/walker with wheels that has a handles bar attached to the front wheels.

U.S. Pat. No. 5,058,912 to Harroun discloses a wheel chair/walker with wheels and an open space in front so a person can use the device as a walker.

U.S. Pat. No. 5,158,313 to Becker discloses a wheel chair/walker that has wheels and an adjustable frame.

U.S. Pat. No. 5,320,122 to Jacobson et al. discloses a wheel chair/walker with wheels invention that has a seat which is spring biased to a raised position.

U.S. Pat. No. 5,716,063 to Doyle et al. discloses a wheel chair/walker with wheels and a brake locking system for the wheels.

In the present invention a combined wheel chair and walker with wheels has a removable seat with the uprights for the wheels having a crank and screw gears for adjusting the height of the walker all as will be detailed in the specification that follows hereafter.

### SUMMARY OF THE INVENTION

This invention relates to a combined wheel chair and walker with wheels and a removable seat. The upright supports to which the wheels are attached have a crank and screw gears to provide for the adjusting of the vertical height of the walker.

It is the primary object of the present invention to provide for an improved combined wheel chair and walker.

Another object is to provide for such a combination in which the seat is removable revealing the walker seat with the height of the walker being adjusted by a hand operated crank.

These and other objects and advantages of the present invention will become apparent to readers from a consideration of the ensuing description and the accompanying drawings.

### BRIEF DESCRIPTION OF THE DRAWINGS

FIG. 1 is a perspective view of the present invention taken from the front showing the height adjustment crank.

FIG. 2 is a perspective view of the FIG. 1 invention as viewed from the rear.

FIG. 3 is a diagram of the crank operated height adjustment mechanism.

FIG. 4 is a perspective view of the seat cushion with its attachment grips.

FIG. 5 is a top view of the walker seat.

### DESCRIPTION OF THE PREFERRED EMBODIMENT

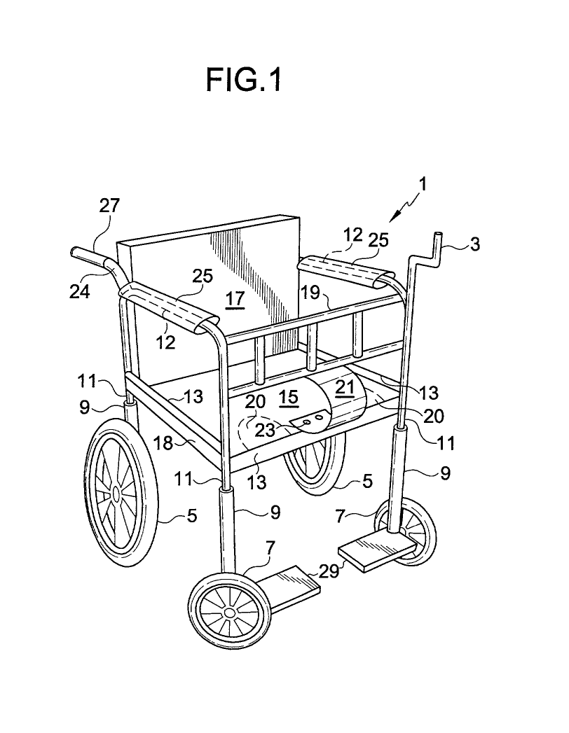

FIG. 1 is a perspective view of the combined wheel chair/walker 1 taken from the front showing the height adjustment hand operated crank 3. The base or lower ground engaging portion of the invention consists of two large rear wheels 5 and two smaller front wheels 7. Four lower metal tubular upright legs 9, three of which are shown, also form part of the base and are journal led to each wheel at their lower ends to permit their rolling of the wheels. The front wheels 7 are fixed to the legs 9 by a swivel connection to permit steering of the invention. Each of the lower base leg sections 9 have a hollow interior which permits an upper leg segment 11 to fit within them and move up or down by actuating the crank 3.

Each upper leg segment 11 is hollow, interconnects and is fixed to the other upper leg segments by horizontally frame members 13 to form a rectangular configuration when viewed from above. Within this formed configuration an upper removable seat 15 is placed on the lower frame members 13. Generally perpendicular to the horizontally disposed seat 15 is a backing 17. Directly below the seat 15 is a standard walker seat 18, shown in dotted line format, which is revealed when the covering seat 15 is removed. The walker seat 15 (see FIG. 5) is supported by the frame on three sides and sags slightly downwardly and has two frontal substantially identical cut out portions 20. A snap is located on the seat 18 on its portion between the cut out portions 20. The cutouts 20 each allow a leg of a user to fit through them while the snap permits a removable strap or belt 21 to be joined to them and to extend around a upper horizontally disposed bar 19. Both the cutouts and main portion of the seat 18 are cover able by the removable seat 15.

The bar 19 is located in the front of the wheel chair and is removable from the supporting vertical frame members 11. As shown, this bar is located above the seat 15 and adjacent its forward end. At about the mid portion of the bar the restraining belt 21 can be fixed around to the bar. The lower portion of the belt is removably attached to the front frame member 13 by conventional interconnecting snaps 23 fixed to both this member and the seat 18.

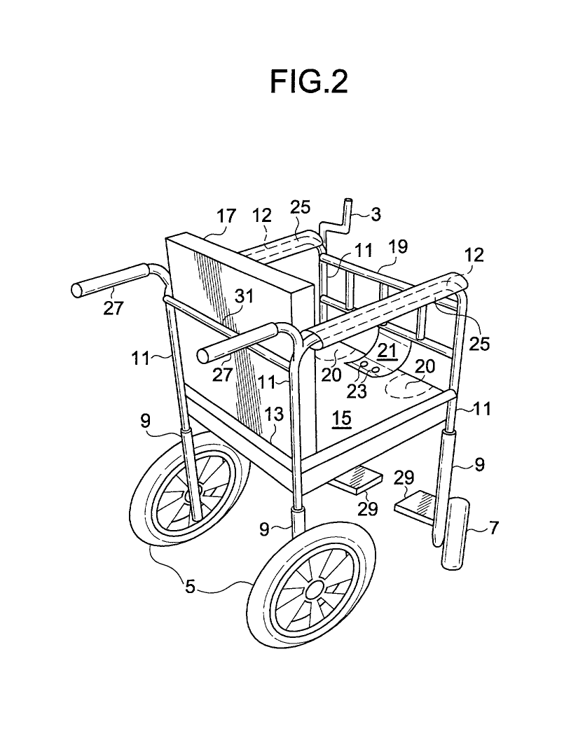

At the upper ends of upper leg segment members 11, the two front members 12 that are hollow and extended horizontally towards the rear of the wheel chair. These two bent horizontally hollow segments 12 are shown in dotted line format and are covered by the arm rest cushions 25 fixed to them. The two parallel rear vertical leg segments 11 are joined to the bent horizontal segments 12 portions at their respective ends as shown in FIG. 2. Extending from the rear of leg segments 12 are two small bent extensions facing towards the rear which form the handles 24 with the covered hand caps 27, one of which is shown. As is conventional, these handles may be used to push and control the operation of the wheel chair/walker 1. Two conventional lower front fold-up foot rests 29 are shown adjacent the lower front wheels 7 facing inwardly towards each other in their down position or foot rest position.

FIG. 2 is a perspective view of the FIG. 1 wheel chair/walker 1 as viewed from the rear. In this view the two rear wheels 5 and their hollow lower leg segments 9 are more clearly shown. The rear lower joining horizontally disposed frame member 13 between the two rear wheels is also shown. Parallel and above this rear member 13 is the joining cross hollow frame member 31 forming the support for the backing 17. All upper framing members 11, 12, 13, and 31 are rigidly held together. Thus, these upper framing members move as an unit in unison up or down relative to the lower frame legs 9 and the front and rear wheels, etc. by actuating the hand crank. The mechanism to move the upper portion of the wheel chair/walker 1 extends through the hollow interior portion of the four vertical support leg segments 11 and their interconnecting upper horizontally disposed hollow joining members 12 including the member 31.

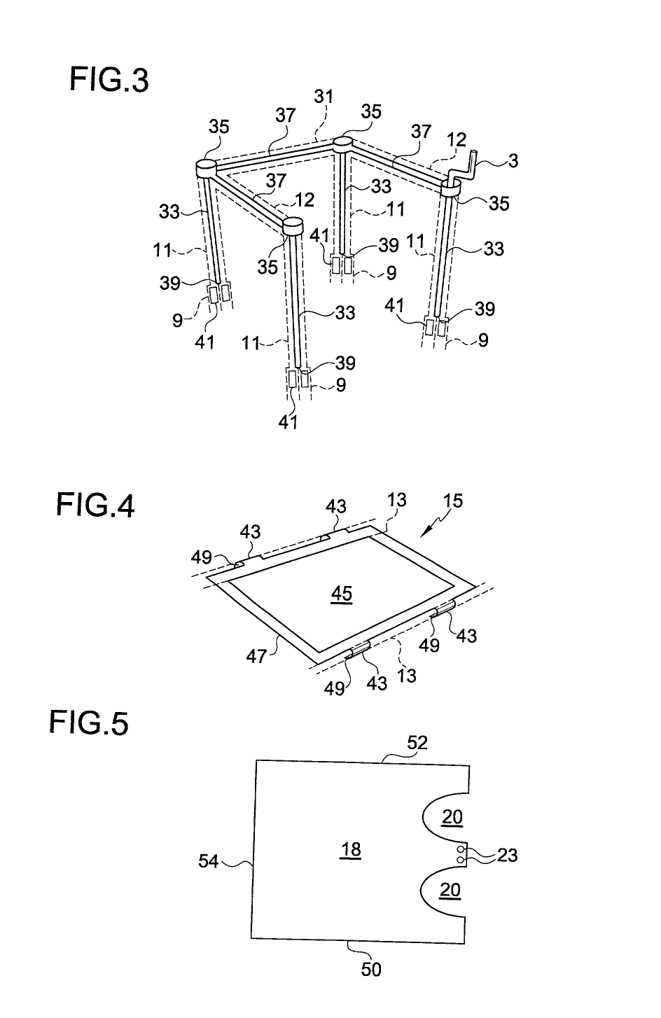

FIG. 3 is a diagram of the crank operated height adjustment mechanism. Only the crank 3 and the small upper portion of its supporting shaft 33 is visible in FIGS. 1-2. Each individual shaft 33 has an upper socket 35 fixed to the shaft near its top end. Extending between the four sprockets are joining connecting linkages, shown here as continuous chains 37. Surrounding the chains along their lengths are the hollow horizontally disposed frame members, shown in dotted line format, previously mentioned, namely the two side members 12 and the rear member 31. The vertically disposed shafts 33 extend into the hollow interior of legs 11 and have lower end worm gears 39 or gear engagement members. These conventional worm gears mesh with interior threaded portions 41 or gear engagement members that extend along a bore hole portion of the hollow interior of the lower leg segments 9 (whose upper ends are shown in dotted line format) to provide for the vertical raising or lowering of the upper frame portion of the wheel chair/walker 1 relative to the base made up of the legs 9 and the wheels, etc. as the crank is turned. Conceivably other types of engagements between the lower ends of the shafts and the lower leg segments are also possible to raise and lower the shaft relative to the lower frame with is ground engaging wheels.

FIG. 4 is a perspective view of the covering seat cushion 15 with its attachment grips 43. The rectangular interior portion 45 is made up of a soft foam cushioning material which is fixed to a larger surrounding rectangular more rigid base 47. Each of the grips 43 are opened on the side 49 facing inwardly toward cushion 45 and are sized to fit around most of the diameter of a tubular framing member 13, shown in dotted line format. Since, the grips are made of a flexible material, like spring steel their openings may be expanded to permit them to be removed from the tubular members 13 by pulling upwardly on the seat 15. Conversely, the formed grip openings 49 may be forced to expand to provide a greater opening by simply pushing down on the seat 15 when properly aligned over the members 13. When removed from the underlining fixed walker seat 18, the seat 15 may be attached to the walker when not in use.

FIG. 5 is a top view of the underlining walker seat 18 that may be covered by the removable seat 15. The main or larger area portion of the walker seat has its three sides 50, 52 and 54 firmly fixed to the three side and rear horizontal frame members 13. Rear side 54 would be joined to rear frame member 13 while sides 50 and 52 would be fixed to the two opposite side frame members 13, as best shown in FIGS. 1 and 2.

The purpose of the present invention is to provide increased mobility and independence to a physically challenged person, such as a senior citizen. It may be used when an individual is in a seated position on seat 15 either by the individual them self or by another at the control handles 24. The height above the ground engaging wheels can be adjusted by crank 3 to provide for different leg sized user or to let a user have their legs and feet touch the ground more firmly by lowering the seated upper portion. To provide for its use in a shower, the material making the wheel chair/walker 1 could be made waterproof. In the walking mode, a user's feet would touch the ground while the user may stands up and walks. If the user were to become weak or have an episode of loss of consciousness, they would fall into the lower seat 18 and be protected from falling to the ground.

Many different types of material can be used to construct the various components of the wheel chair/walker 1, including multiple rust resistant metal alloys. Various sizes could also be made to accommodate different sized users. The wheel chair/walker would find particular need for user with weak legs who is unable to stand safely on their own. By allowing them to use the walker in an upright position, their leg muscles would still get exercise as they walk around to move the chair to the extend they are able.

Although the preferred embodiment of the present invention and the method of using the same has been described in the foregoing specification with considerable details, it is to be understood that modifications may be made to the invention which do not exceed the scope of the appended claims and modified forms of the present invention done by others skilled in the art to which the invention pertains will be considered infringements of this invention when those modified forms fall within the claimed scope of this invention.

What I claim as my invention is:

1. A combined wheel chair and walker comprising:
a lower frame having four vertically disposed lower leg segments with wheels mounted to each of the segments, each of said lower segments having an upper hollow interior portion with gear engagement members;
an upper frame with a horizontally disposed first seat and four upper vertically disposed leg segments, one of said leg segments being adapted to fit within the hollow interior portion of each of said lower frame leg segments;
each of said upper leg segments having a hollow interior portion;
a shaft with an upper sprocket fixed to the shaft disposed within the hollow interior portion of each of said upper leg segments, said shaft having a lower gear engagement member,
each of said shafts being movable within the upper leg segment by the engagement of a gear engagement member of an upper leg segment with a gear engagement member in the lower leg segment; and
a hand operated member mounted on one of said sockets,
the socket of the shaft with said hand operated member having a connecting linkage to the sprocket of an adjacent shaft and each of the other sprockets being connected by a connecting linkage whereby the movement of the hand operated member will move the linkages and their connected sprockets and shafts within the upper leg segments.

2. The combined wheel chair and walker as claimed in claim 1, wherein said upper frame has horizontally disposed connecting frame members between the upper leg segments that are rigidly connected to each of them.

3. The combined wheel chair and walker as claimed in claim 2, wherein said first seat is mounted to a plurality of of said horizontally disposed connecting frame members.

4. The combined wheel chair and walker as claimed in claim 2, also including a second removable seat mounted over said first seat.

5. The combined wheel chair and walker as claimed in claim 4, also including upper handles mounted to the upper frame to control the movement of the wheel chair and walker on its supporting wheels.

6. The combined wheel chair and walker as claimed in claim 4, wherein said second seat has grips attached that engage the horizontally disposed members of the upper frame.

7. The combined wheel chair and walker as claimed in claim 3, wherein said gear engagement members of the lower leg segments consists of threads that engage gear engagement members consisting of worm gears on the upper leg segments.

8. The combined wheel chair and walker as claimed in claim 7, wherein said connecting linkage to the sprockets consists of a chain mount around the socket of each shaft.
